(19) United States
(12) Patent Application Publication
(10) Pub. No.: US 2005/0188612 A1
(43) Pub. Date: Sep. 1, 2005

(54) Plant pot that fertilizes when it biodegrades

(76) Inventor: Michael Vincent Theuer, Bellefonte, PA (US)

Correspondence Address: MICHAEL V. THEUER, 442 E. LINN STREET, BELLEFONTE, PA, 16823, US

(21) Appl. No.: 11/070,795

(22) Filed: Mar. 3, 2005

Related U.S. Application Data
(63) Continuation of application No. 10/613,319, filed on Jul. 7, 2003.

(51) Int. Cl. A01G 9/02

(52) U.S. Cl. 47/65.7

(57) ABSTRACT

The current invention is a biodegradable plant pot with natural porated into its walls. This plant-pot invention is given a thin, ting on the inside and the bottom-outside to deter biodegradation contains a growing plant and rests in a drainage tray. When the pot it contains are transplanted into biologically active soil, the pot from the outside to the protective coating inside. The plant roots h the coating and into the composted nutrients of the biodegraded this way, the current invention biodegrades and fertilizes.

### CROSS-REFERENCE TO RELATED APPLICATIONS

U.S. Patent Documents
1) U.S. Pat. No. 4,021,965 Norris, May 10, 1977 Fertilizer and pesticide dispensing stake
2) U.S. Pat. No. 6,231,970 Andersen, et al., May 15, 2001 Thermoplastic starch compositions incorporating a particulate filler component
3) U.S. Pat. No. 6,286,252 O'Neal, Sep. 11, 2001 Delivery system for horticultural agents

U.S. Patent Applications
4) Patent Application 20040259736 Dieing, Reinhold; et al., Mar. 23, 2004 Biodegradable solid preparation of a phytopathological agent with delayed active substance release

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

Plant pots made of petroleum-based plastic are widely used for propagating plants. Ranging in style, shape and size from 1-inch-cubed to 5-gallons-circular for home and commercial use, almost 470 million pounds of petroleum-based plastic pots or approximately 1.8 trillion individual pots were purchased in the United States in 2000 by greenhouses and nurseries alone¹.
¹ (ComDetition in the Horticultural Container Market in the Southeastern United States, University of Florida Institute of Food and Agricultural Sciences Food & Resource Economics. A. W. Hodges, and J. J. Haydu, Mar. 12, 2001)

Petroleum-based-plastic plant pots create two distinct problems. First, most petroleum-based-plastic plant pots are thrown out after use. Such disposal appears to occur because reusing these pots is often cost prohibitive for commercial growers, and because home recycling of these pots is barred in many U.S. municipalities. As a result, over 90% of these pots purchased in the United States in 2000 were land filled above. The second problem is that over 20% of plants grown in these pots will be stunted and 2% will die from a shock to their roots upon being removed from their container and planted elsewhere² (i.e., transplanted).
2 (personal communication, Woodrina's Floral Gardens. PA Dave Woodring, April 2002)

Fortunately, the waste and the root shock associated with petroleum-based pots are eliminated by pots that biodegrade. Biodegradable pots made of peat moss, paper or wood-pulp can be placed entirely in the ground along with the plant grown in them and over time the pot will biodegrade and become part of the soil. Likewise, pots made of biodegradable plastic will biodegrade and become part of the soil when placed in the ground. As a result, biodegradable pots (bio-pots) eliminate the need to discard a pot and to transplant.

Unfortunately, bio-pots have two distinct problems of their own. First, these pots are typically limited structurally. Peat and other pressed-fiber bio-pots kept dose together during plant propagation often become so wet they disintegrate before transplanting is optimal. Also, pressed-fiber bio-pots often become too soft to handle in the automated planting systems of commercial greenhouses. In the same way, bio-pots made from plastic sometimes soften so much due to degradation from the inside that commercial growers cannot contain a plant in them until purchased by a retail consumer. And, consumers sometimes have difficulty containing their plant before they can get the plant home and into the ground³. The second problem is that bio-pots cost up to 60% more than petroleum-based-plastic pots⁴. Consumers and growers may perceive this higher cost to be more expensive than the biodegradability is worth. Structural limits and high cost might explain partly why pots made from biodegradable materials continue to be less widely used than petroleum-based-plastic pots ⁴above.
³ (personal communication, Woodrino's Floral Gardens, PA Dave Woodring, April 2002)

⁴ (Making Packaging Greener—Biodegradable Plastics, Australian Academy of Science. D. Saft, February 2002

### BRIEF SUMMARY OF THE INVENTION

The current invention is a bio-pot that improves on present bio-pots in three ways. First, the current invention remains sturdy until it and the growing plant it contains are transplanted into the ground. This sturdiness is the result of a thin coating on the interior and exterior bottom of the bio-pot that protects the pot from biodegradation before it is transplanted. Second, the current invention competes in price with pots made from traditional petroleum-based plastic. This price competitiveness is due to a unique ingredient added during production. As a result of this ingredient, the invention can be made from low grade biodegradable plastic, which costs up to half the standard-grade price. Finally, the invention improves plant growth. This benefit to plants results after transplantation and the invention biodegrades releasing the unique ingredient alluded to above, fertilizer. These three improvements, especially the last, result in a better bio-pot.

### BRIEF DESCRIPTION OF THE SEVERAL VIEWS OF THE DRAWING

Not Applicable

### DETAILED DESCRIPTION OF THE INVENTION

The current invention has three components. The first component is biodegradable plastic (bio-plastic). A bio-plastic is one that typically degrades in soil under conditions of moisture, microbial action and elevated temperature (i.e., compost environment) in around two months. Such bio-plastics range from ones derived from animal proteins to others made from plant starches, some of which have been commercially available since the mid 1980's⁵. A commercially available bio-plastic is used in the current invention to ensure a steady and large supply of the material to support potentially steady and large sales of the invention. Specifically, Polylactic Acid (PLA), a corn-based bio-plastic in pellet form which melts at 390° is used. More information on PLA is found in the attached “Injection Molding Process Guide” from the manufacturer, Cargill Dow (see APPENDIX A). However, other derivations or manufactures of biodegradable plastic have been used successfully by the inventor as long as the bio-plastic melts below 400°. If the bio-plastic used melts above 400°, the second component may burn.
⁵ (History of Plastics New South Wales Process Manufacturing Industry Training Body Limited. D. E. Fahey, Jul. 28, 2001)

The second component of the current invention is natural fertilizer. Natural fertilizer is a naturally occurring substance that releases an essential plant nutrient(s) (i.e., nitrogen [N], potassium [P], phosphorous [K]) and/or micronutrient(s) (e.g., zinc), primarily after being biodegraded by soil microbes. Any natural fertilizer in powder form with a kindling temperature above 400° can be used as the inventor has discovered. Also any practical nutrient level (e.g., NPK=5%-3%-3% or NPK=4%-4%-0%) can be used. In this case, Grow Joe™ fertilizer (NPK=6%-8-6) made with used coffee grounds and developed by the inventor is used. More information on Grow Joe fertilizer is available from the fertilizer label, attached as APPENDIX B.

The third component of the current invention is a protective coating. A protective coating in this case is one that protects the bio-pot from biodegrading before it and the plant it contains are transplanted. After transplantation and the invention biodegrades, the protective coating is also one that is penetrable by the roots of the growing plant. Coatings that meet these criteria are varied. Ones that have worked successfully for the inventor include latex paint, polyurethane and lacquer, thinly applied. In the current invention, shellac is used. Shellac is a natural plastic derived from the protective shell of the Asian Lac Beetle. It can be heated and molded into objects like 78 RPM records or pulverized then suspended in an alcohol solution for application by painting,⁶ as is done today in protective coatings for produce. Shellac in solution is used in the current invention because it is natural, biodegradable over time in a compost environment, widely available, and easily applied.
⁶ (Shellac—a Traditional Finish Still Yields SuDerb Results, Homestead Finishing Products. J. Jewift, 1999)

The current invention is made in the following way. First, the PLA and Grow Joe are dry mixed in roughly equal proportions by weight. This mixture is then processed using conventional plastic-molding technology. Both compression and injection molding have been used successfully by the inventor simply by following the molding guidelines provided by the bio-plastic manufacturer. However, injection molding (see APPENDIX A) is preferred for the current invention so that large volumes of end product can be produced to accommodate potentially large sales of the invention. Specifically, the PLA/Grow Joe mixture is added to the injection-mold-machine hopper where it is drawn into the injection machine, melted, mixed and injected into a standard pot-shaped mold or “cavity.” This cavity can be almost any size and shape design within the parameters of the molding machine and the bio-plastic being used, as for any cavity. And a plant pot of almost any size and shape can result. As for the current invention, the bio-pot is a traditional cone-shape, 4 inches wide and 4 inches high with a flat bottom and ¼-inch drainage hole. Within the invention walls, the PLA now encapsulates the Grow Joe. Yet the invention remains rigid as is the case in prior art (noted under CROSS-REFERENCE TO RELATED APPLICATIONS above) where bio-plastics are mixed with filler (no. 2), or agricultural chemicals (nos. 1, 3 & 4). Coincidentally, the invention has now taken on the color of the fertilizer rendering the color of the bio-plastic immaterial, which is why a less expensive bio-plastic of sub-standard color can be used.

Liquid shellac is then applied to the current invention. Standard application technologies like brushing, spraying and dipping have been used by the inventor successfully. And the application can be done by hand or by automation, as long as the coating is uniform and approximately one micron thick. In the current invention, a semi-automated spray process is used. The molded bio-pots are manually placed on their side onto a conveyor belt which conveys the top and bottom of the pots past conventional spray-paint guns. The speed at which the pots pass the spray guns is adjusted so that the guns apply a uniform layer of liquid shellac to the pot interior and exterior bottom. The sprayed pots are then conveyed in front of heaters for drying. Standard, forced-air heaters or infra-red heat lamps can be used. In the current invention, infra-red lamps are used. The lamps are positioned a specific distance away from the conveyor and the conveyor is adjusted to a specific speed so that the bio-pot surfaces do not exceed 400° F., which is 10° above the bio-plastic melting point. This temperature can be achieved through trial and error by adjusting the lamp distances and/or conveyor speed, then checking the pot surface temperatures using an infra-red heat sensor. At 400°, the shellac dres and fuses to the PLA, making the otherwise tenuous shellac coating difficult to scratch off of the pot surface. The end result is a protective coating essential to the invention's function.

Shellac protects the current invention from biodegradation while the invention contains a growing plant. Under moist conditions the shellac coating softens but continues to resist water permeation. Therefore, shellac on the bio-pot interior and bottom deters biodegradation from a growing plant and from a drainage tray in which the pot might rest and continues to do so, as the inventor has discovered, well beyond the point where a plant grows ready for transplanting (up to six months). After transplantation into biologically active soil, the pot biodegrades from the outside to the softened-shellac coating inside in around two months. Coincidentally, the fertilizer facilitates the degradation of the bio-plastic, which is why a less expensive bio-plastic of substandard molecular weight and degradation rate can be used. At this point, the plant roots break through the softened shellac and into the biodegraded invention, most of which has become composted fertilizer. In this way, the current invention fertilizes when it biodegrades, which the attached research study confirms (see APPENDIX C).

Only natural fertilizers are effective in the current invention. Natural fertilizers release the bulk of their nutrients to plants after being decomposed by soil microbes, that is, turned into compost. In contrast, chemical fertilizers release the bulk of their nutrients upon being dissolved by water. If chemical fertilizers were used in the current invention, the fertilizers would dissolve and wash away in the soil out of reach of the plant roots before the roots were able to break through the protective coating. The inventor has discovered that even chemical fertilizers designed to release slowly (e.g., OsmocoteTM) pose this leaching problem. Such a problem renders a chemical fertilizer ineffective in the current invention.

Finally, the materials used to make the current invention can be used to make other products. The current materials can be used to produce construction stakes, fertilizer spikes, golf tees, and other plant propagation products (e.g., large bio-pots, seedling trays or agricultural films). Such products would eliminate disposal problems and costs at the end of the products' useful lives. And the decomposition of these products would bring about the added benefit of fertilization.

[image]

[image]

[image]

[image]

[image]

[image]

[image]

[image]

[image]

[image]

[image]

[image]

[image]

[image]

[image]

1. A biodegradable plant pot with natural fertilizer incorporated into its walls.

2. A mixture of biodegradable plastic and natural fertilizer for making the plant pot in claim 1 and other objects whose end use would be to biodegrade and fertilize.

3. The use of a protective coating on the plant pot in claim 1—the pot made from the mixture in claim 2—in order to deter biodegradation wherever the coating is applied, and yet to allow penetration by plant roots after the mixture in claim 2 has biodegraded.
